(19) United States
(12) Patent Application Publication
(10) Pub. No.: US 2008/0209968 A1
(43) Pub. Date: Sep. 4, 2008

(54) Processes for Treatment of Wastewater, Separation, Deodorisation and Re-Use of Biosolids

(75) Inventors: Daniel Maxwell Drew, Victoria (AU); Alfred Norman Ducksbury, Victoria (AU); Darryl K. Josey, Queensland (AU)

Correspondence Address: BUCHANAN, INGERSOLL & ROONEY LLP, P.O. BOX 1404, ALEXANDRIA, VA, 22313-1404, US

(73) Assignee: NAUVEAU TECHNOLOGY INVESTMENTS LTD., PORT VILA (VU)

(21) Appl. No.: 10/525,420

(22) PCT Filed: Aug. 27, 2003
(86) PCT No.: PCT/AU03/01090

§ 371 Date: Dec. 7, 2007

(30) Foreign Application Priority Data
Aug. 27, 2002 (AU) 2002951011
Sep. 16, 2002 (AU) 2002951437

(51) Int. Cl. C02F 1/52; C02F 1/58; C02F 9/04; C05F 7/00; C05F 17/00

(52) U.S. Cl. 71/12; 210/724; 422/5; 71/64.01; 71/14; 71/21; 71/24

(57) ABSTRACT

The present invention relates to a process for treating wastewater containing suspended solids comprising adding to the wastewater a treating substance in an amount sufficient to enhance at least one of (a) the settling rate of the solids, (b) the bulk density of the solids and (c) the filterability of the solids, said treating substance being selected from the group consisting of (i) bauxite refinery residue known as red mud, and (ii) red mud that has been at least partially reacted with calcium and/or magnesium ions so as to have a reaction pH, when mixed with five times its weight of water, of less than 10.5. In addition, the invention relates to processes for reducing the concentration of dissolved phosphorus-containing species in wastewater, for decreasing the odour of a material having an odour due to the presence of one or more sulphur-containing substances and for decreasing the propensity to develop odours and a composting process.

### TECHNICAL FIELD OF THE INVENTION

The invention relates to processes for treatment of waste water, for reducing the concentration of soluble phosphorus species in water, especially wastewater, for improving the ability of suspended and dissolved solids to settle, for decreasing the odour of odoriferous materials or for decreasing the propensity of such materials to develop an odour over time, and to composting processes in which a compostable material is mixed with a source of microorganisms.

### BACKGROUND OF THE INVENTION

Processes for the separation of solids of biological origin that are suspended in wastewater are widely practised. The efficient separation of the solids from the water and the disposal of the separated solids present difficulties, however.

The separation of solids from wastewater, especially the separation of sewage sludge, is technically difficult because typically the solids are very finely divided and of such a nature that at best with existing technologies sludges having a solids content in the range of 10-12% by weight can be achieved. Such processes typically require polyelectrolytes to be added to the water to assist the coagulation of the solids. However, polyelectrolytes are expensive to use.

Furthermore, disposal or further treatment of the sludge separated in this way is associated with difficulties. In a typical wastewater treatment process the insoluble matter, which may be separated from the effluent liquid by any of a number of processes, is typically discharged to the environment, either as landfill, or for agricultural purposes, either alone or as a supplement in a composting process or other fertilising substance. After separation, the sludge typically develops disagreeable odours that are considered to be disadvantageous to the environment or for their proposed end use.

In addition, dissolved phosphorus is damaging to the aqueous environment because it, along with nitrogen, is a driver of organic growth. When aquatic growths capture inflowing nitrogen, phosphorus and other nutrients, the new growth settles, dies and releases its nutrients into the upper waters. These, and further inflowing nutrients, encourage repetition of the growth-regrowth cycle resulting in the silting up of the receiving body and subsequent ecological damage. This process of eutrophication by phosphorus is particularly disadvantageous to shallow fresh water bodies where growth is nutrient limited and the most influential nutrient is phosphorus.

Accordingly, authorities propose stringent limits on the discharge of total effluent phosphorus to surface waters. Typical limits for total effluent phosphorus vary, according to receiving body and local authority, in the range 0.1-1 mg/L. Total effluent phosphorus is the sum of the concentration of soluble phosphorus and the amount of phosphorus present in effluent suspended solids (expressed in units of mass/volume). The latter is the product of the amount of effluent suspended solids in the effluent, in units of mass/volume, and the fraction of phosphorus in the effluent suspended solids dry mass. Thus, for example, under typical discharge conditions, there may be 20 mg/L effluent total suspended solids containing 2.5% phosphorus on a dry weight basis. In that case, the amount of phosphorus present in the effluent suspended solids is 0.5 mg/L.

Additionally, in a typical wastewater process, the effluent develops an odour during the treatment process and the odour may be discharged to the atmospheric environment in contravention of local regulation. The odour is typically produced by the biological production of organic and inorganic volatile sulfur compounds and is typically more evident as the effluent is stored on site or applied to land for irrigation purposes. Similarly, dewatering procedures and drying in lagoons, are costly and environmentally unsatisfactory because the sludge, during drying, and storage tends to have an offensive smell.

Alternatively, the sludge may be used as a source of microorganisms for composting by adding it to green waste or other similar degradable materials. However, the composting process typically also produces disagreeable odours and in many instances requires the purchase of significant amounts of green waste to permit all the available sludge to be utilised. Furthermore, existing composting processes may not develop sufficiently high temperatures to sterilise the resulting composted material, rendering it unsuitable for sale or for use in various situations.

There is therefore a need for a water treatment process that produces sludge and treated water that have reduced phosphorous and odour, or preferably no odour, and that do not develop odour over time.

Currently, soluble phosphorus is typically removed by precipitation of insoluble metal phosphates produced by reacting the soluble phosphorus with one or more metal ions, typically aluminium, iron and/or calcium. This prior art process for reducing the concentration of soluble phosphorus is described in Biological and Chemical Systems for Nutrient Removal; Water Environment Federation, Virginia, USA; Municipal Subcommittee of the Technical Practice Committee; 1998.

With reference to the use of ferric ion, the reactions involved in the process are:

Fe³⁺+H₂PO₄⁻→FePO₄+2H⁺ and

Fe³⁺+3H₂O→Fe(OH)₃+3H⁺

Similar reactions apply to other metal ions that react to precipitate phosphorus.

The formation of metal hydroxides thus adds a competing reaction to the process of precipitation of metal phosphates and requires the addition of metal ions in excess of the stoichiometric amount indicated by the first reaction. The competing reactions also imply a lower limit to the residual soluble phosphorus remaining in the effluent. This lowest theoretically achievable concentration C_{Pres} is calculated as:

C_{Pres}=[H₃PO₄]+[H₂PO₄⁻]+[HPO₄²⁻]+[PO₄³⁻]+[FeH₂PO₄²⁺]+[FeHPO₄⁺].

The theoretical value is a function of pH and can be demonstrated to be 0.04 mg/L at pH 6.8.

The overall reaction for the removal of phosphorus by Fe³⁺ can be written:

1.6 Fe³⁺+H₂PO₄⁻+3.8 OH⁻→Fe_{1.6}(H₂PO₄)(OH)_{3.8}

and thus quantifies the stoichiometric Fe³⁺/P molar ratio at which the theoretical minimum residual phosphate will be achieved as about 1.6 when the pH is such that the predominant soluble phosphorus species is H₂PO₄⁻, which is the case for most wastewaters.

However, the present best practice for soluble phosphate removal from treated effluent by ferric ion addition can only achieve a minimum residual soluble phosphorus of 0.06 mg/L at a molar ratio (Fe³⁺/P_{removed}) usually well above 4, and typically about 10. Present practice therefore requires at least 3 times and usually 6 times the theoretical stoichiometric amount of metal ions to compensate for pH variations which occur in practice to attain the minimum residual soluble phosphate concentration.

Accordingly, there is a need for a process for reducing the concentration of soluble phosphorus in water that utilises added metal ions more economically. A very desirable process would be one that enables the use of an amount of metal ions at or close to the stoichiometric amount and which is less sensitive to pH.

Existing water treatment processes exhibit a number of other shortcomings, which are described below.

Discharged effluent is typically subjected to regulation for the concentration of suspended solids, the limits imposed for total suspended solids being typically 20 mg/L. In order to comply with these regulations costly separation procedures are undertaken. The complexity and cost of these procedures is greatly affected by the quantity and physical properties of the suspended solids. Typically such procedures as dissolved air flotation or belt filtration augmented by flocculation and polyelectrolytic coagulation are used. The cost of these coagulation and flocculation chemicals is substantial. Procedures that can modify the bulk density, filterability and sludge volume of the suspended solids can significantly reduce these costs and are thus economically advantageous. Furthermore, reduction in effluent suspended solids concentration will also markedly reduce the total effluent phosphorus concentration.

Additionally, certain metal ions are toxic to the ecosystem of the body receiving effluent water and are subject to regulation. In sewage treatment systems the operator typically controls the influent metal ion concentration by acceptance testing. However, as the limits for toxic metals are extremely low (the limits for most toxic metals are well below 10 mg/L) there is a need for economical removal processes, especially in the control of accidental contamination. Furthermore, the relevant authorities require the immobilisation of metal ions in sludges or solid wastes, which are to be discharged to the environment, as characterised by the Toxicity Characteristic Leaching Procedure (TCLP; USEPA Method 1311). Untreated sludges containing toxic metals may fail the TCLP test. Accordingly, there is a need for water treatment processes that produce sludges that pass the TCLP procedure.

It is an object of the present invention to at least partially satisfy one or more of the above mentioned needs.

There is therefore a need for improved processes for the treatment of wastewater containing suspended solids, for the reduction in concentration of soluble phosphorous, for the deodorisation of sewage sludge and other odoriferous materials, for decreasing the propensity of such materials to develop disagreeable odours over time, and for improved composting processes.

Surprisingly, the present inventors have found that these needs can at least partially be met by the use of a material derived from bauxite refinery residue that is commonly known as “red mud”.

### SUMMARY OF THE INVENTION

According to a first embodiment of the invention there is provided a process for treating wastewater containing suspended solids comprising adding to the wastewater a treating substance in an amount sufficient to enhance at least one of (a) the settling rate of the solids, (b) the bulk density of the solids and (c) the filterability of the solids, said treating substance being selected from the group consisting of (i) bauxite refinery residue known as red mud, and (ii) red mud that has been at least partially reacted with calcium and/or magnesium ions so as to have a reaction pH, when mixed with five times its weight of water, of less than 10.5.

According to a second embodiment of the invention, there is provided a process for reducing the concentration of dissolved phosphorus-containing species in water containing dissolved phosphorus-containing species, the process comprising the steps of
(a) dispersing in said water an amount of a treating substance,
(b) adding to said water an amount of at least one metal ion sufficient to at least partially precipitate a phosphorus-containing compound of said at least one metal, and
(c) removing solids present in said water therefrom to produce a treated water; wherein said treating substance is selected from the group consisting of (i) bauxite refinery residue known as red mud, and (ii) red mud that has been at least partially reacted with calcium and/or magnesium ions so as to have a reaction pH, when mixed with 5 times its weight of water, of less than 10.5.

Typically, the red mud that has been at least partially reacted with calcium and/or magnesium ions has a reaction pH, when mixed with 5 times its weight of water, of between 8 and 10.5.

In a third embodiment, the present invention provides a process for decreasing the odour of a material having an odour due to the presence of one or more sulphur-containing substances, comprising adding to said material a treating substance in an amount effective to decrease the odour of the material, wherein the treating substance is selected from the group consisting of (i) bauxite refinery residue known as red mud, and (ii) red mud that has been at least partially reacted with calcium and/or magnesium ions so as to have a reaction pH, when mixed with five times its weight of water, of less than 10.5.

In a fourth embodiment, the present invention provides a process for decreasing the propensity of a material to develop an odour due to one or more sulphur-containing substances, comprising adding to said material a treating substance in an amount effective to inhibit the development of odour in the material, wherein the treating substance is selected from the group consisting of (i) bauxite refinery residue known as red mud, and (ii) red mud that has been at least partially reacted with calcium and/or magnesium ions so as to have a reaction pH, when mixed with five times its weight of water, of less than 10.5.

In a fifth embodiment, the present invention provides a composting process in which a compostable material is mixed with an amount of a material containing microorganisms and the microorganisms convert the compostable material to compost, wherein the mixture of compostable material and the material containing microorganisms further contains a treating substance selected from the group consisting of (i) bauxite refinery residue known as red mud, and (ii) red mud that has been at least partially reacted with calcium and/or magnesium ions so as to have a reaction pH, when mixed with five times its weight of water, of less than 10.5.

### DETAILED DESCRIPTION OF THE INVENTION

In the processes of the present invention, the treating substance is either the bauxite refinery residue known as “red mud”, or “red mud” that has been at least partially reacted with calcium and/or magnesium ions so as to have a reaction pH, when mixed with 5 times its weight of water, of less than 10.5, typically in the range of 8.0 to 10.5. Processes for the reaction of red mud with a solution of calcium and/or magnesium ions are described in International Patent Application No. PCT/AU01/01383, the contents of which are incorporated herein in their entirety, or they may involve the reaction of red mud with sufficient quantity of seawater to decrease the reaction pH of the red mud to less than 10.5, typically in the range of 8.0 to 10.5. For example, it has been found that if an untreated red mud has a pH of about 13.5 and an alkalinity of about 20,000 mg/L, the addition of about 5 volumes of world average seawater will reduce the pH to between 9.0 and 9.5 and the alkalinity to about 300 mg/L.

In summary, as taught in International Patent Application No. PCT/AU01/01383, a process for reacting red mud with calcium and/or magnesium ions may comprise mixing red mud with an aqueous treating solution containing a base amount and a treating amount of calcium ions and a base amount and a treating amount of magnesium ions, for a time sufficient to bring the reaction pH of the red mud, when one part by weight is mixed with 5 parts by weight of distilled or deionised water, to less than 10.5. The base amounts of calcium and magnesium ions are 8 millimoles and 12 millimoles, respectively, per litre of the total volume of the treating solution and the red mud; the treating amount of calcium ions is at least 25 millimoles per mole of total alkalinity of the red mud expressed as calcium carbonate equivalent alkalinity and the treating amount of magnesium ions is at least 400 millimoles per mole of total alkalinity of the red mud expressed as calcium carbonate equivalent alkalinity. Suitable sources of calcium or magnesium ions include any soluble or partially soluble salts of calcium or magnesium, such as the chlorides, sulfates or nitrates of calcium and magnesium.

A further method by which the treating substance may be prepared comprises the steps of:
(a) contacting red mud with a water soluble salt of an alkaline earth metal, typically calcium or magnesium or a mixture of the two, so as to reduce at least one of the pH and alkalinity of the red mud; and
(b) contacting the red mud with an acid so as to reduce the pH of the red mud to less than 10.5.

Optionally, this process may further include the step of separating liquid phase from the red mud after step (a) and before step (b).

In step (a) of this process, the pH of the red mud is usually reduced to about 8.5-10, alternatively to about 8.5-9.5, alternatively to about 9-10, alternatively to about 9.5-10, preferably from about 9-9.5.

In step (a) of this process, the total alkalinity, expressed as calcium carbonate alkalinity, of the red mud may be reduced to about 200 mg/L-1000 mg/L, alternatively to about 200 mg/L-900 mg/L, alternatively to about 200 mg/L-800 mg/L, alternatively to about 200 mg/L-700 mg/L, alternatively to about 200 mg/L-600 mg/L, alternatively to about 200 mg/L-500 mg/L, alternatively to about 200 mg/L-400 mg/L, alternatively to about 200 mg/L-300 mg/L, alternatively to about 300 mg/L-1000 mg/L, alternatively to about 400 mg/L-1000 mg/L, alternatively to about 500 mg/L-1000 mg/L, alternatively to about 600 mg/L-1000 mg/L, alternatively to about 700 mg/L-1000 mg/L, alternatively to about 800 mg/L-1000 mg/L, alternatively to about 900 mg/L-1000 mg/L, preferably less than 300 mg/L.

In step (b) of this process, the pH is typically reduced to less than about 9.5, preferably to less than about 9.0, and the total alkalinity, expressed as calcium carbonate equivalent alkalinity, is preferably be reduced to less than 200 mg/L.

In the process of the second embodiment of the invention, phosphorus is precipitated by the conventional metal ion chemical process in the presence of a treating substance that enhances the chemical efficiency of the process and improves the filterability of the resultant metal phosphate precipitate. By the use of the treating substance in conjunction with ions of one or more metals capable of forming a precipitate of a phosphorus-containing compound, the present inventors have found that the amount of metal ions that needs to be added to the water to reduce the dissolved phosphorus concentration to about the theoretical limit is at, or close to, the stoichiometric amount, in contrast to currently known methods in which considerably more metal ions are required, as noted above. The quantity of treating substance required to obtain this benefit in the amount of metal ions added has been found, surprisingly, to be essentially independent of the initial concentration of dissolved phosphorus in the water. The amount of treating substance used is thus not critical to the present process. For example, the amount of treating substance can be about 1 g/L or more of water to be treated, but will more usually be not more than about 0.5 g/L, still more usually not more than about 0.3 g/L, even more usually up to about 0.25, 0.2, 0.15 or 0.1 g/L yet more usually up to about 50 mg/L. Typically, the amount of treating substance added will be about 50 mg/L, though beneficial effects on removal of phosphorus can be seen with additions of as little as 10 mg/L.

In step (b) of the process of the second embodiment, the metal ion is typically at least one of iron, aluminium and calcium, still more typically iron, which may be ferric or ferrous iron or a mixture of the two. The amount added is typically not more than 1.5 times the stoichiometric amount required to react with the amount of dissolved phosphorus present, but an excess could be added if so desired. Suitably, the metal ion is added as a soluble salt of the metal such as a chloride, sulfate or the like.

Step (c) of the process of the second embodiment may comprise any suitable procedure for the removal of solids from the treated water, and will typically be preceded by settlement of the precipitated phosphorus-containing compound(s) and any other solids present, suitably until the supernatant water is clear. One or more flocculating agents may be added, if so desired.

Optionally, the process of the second embodiment may include the additional step of adjusting the pH of the water before step (b). Typically, the pH of the water is adjusted, if necessary, to a pH in the range of about 6.5 to 7.5.

Because the treating substance is substantially insoluble in water and is easily dispersed throughout the body of the water it is believed that its presence modifies biosolids that may be present in the water in such a manner as to:
improve filterability—this improves the economics of the treatment process by minimising the need for filter aids, flocculants, and highly technical filtration apparatus, and reduces residual phosphate concentration by more complete removal of phosphorus-containing biosolids;
improve the removal of precipitated insoluble inorganic phosphorus compounds by increasing the efficiency of the reaction between certain metal ions and phosphorus and by reducing the pH effect of that reaction;
eliminate time dependent release of phosphorus from biosolids by stabilising the organic and inorganic solids;
eliminate odour in effluent and separated biosolids;
eliminate post treatment odour generation in separated biosolids and effluent.

Without wishing to be bound by theory, the inventors speculate that these properties are imparted to the solids by interaction with the treating substance at the liquid-solid interface of the dispersed particles of the treating substance and are probably related to the mineralisation and particle size distribution of the treating substance.

The inventors further postulate the following mechanistic interpretation of the observed properties of the treating substance applied to the treatment of wastewater.
1. Treating substance is added to the wastewater, disperses and remains suspended for a finite period.
2. Odorous molecules such as H₂S, methyl mercaptan and other thiols and sulphides interact at the treating substance-wastewater interface and are effectively removed from solution.
3. Other inorganic ions (such as metal ions, phosphate ions and hydroxyl ions) migrate to the treating substance particles and remain in a more or less ordered form adjacent to the mineral structure of the treating substance.
4. Colloidally suspended biosolids in the solution are attracted to the treating substance particles (perhaps by virtue of particle charge attraction) and agglomerate.
5. Ferric ions (or other metal ions) are added and react with the phosphate and hydroxyl ions, at or in the vicinity of the treating substance particles which then act as nuclei around which ferric hydroxide and ferric phosphate flocs agglomerate.
6. The resultant increase in particle size of the suspended solids (agglomeration) causes the suspended matter, ferric hydroxide, ferric phosphate, treating substance, to settle rapidly resulting in improved filterability.

The process of the second embodiment is applicable to the treatment of any soluble phosphorus-containing water, including all soluble phosphorus-containing wastewater, especially where the effluent is discharged to a shallow slow moving freshwater receiving body. The process of at least the second embodiment is especially applicable to the treatment of municipal sewage. Examples of water that may be treated by the process include raw sewage, effluent from a primary, secondary, biological nitrogen removal, or other sewage sedimentation or clarification plant and wastewater from any industrial or agricultural process which contains inorganic or organic soluble phosphorus.

The process of the present invention reduces the concentration of all forms of soluble phosphorus.

The processes of at least the first and second embodiments of the invention may be carried out at any stage in the wastewater treatment process, whether it be physicochemical or biological. It may be used on untreated, fresh sewage (influent) or at any stage within a wastewater treatment plant. However, it is more economically carried out after primary sedimentation and clarification is completed, and preferably after secondary treatment and clarification is completed. Specifically, in the case of sewage treatment, the process is preferably, but not necessarily, carried out after secondary clarification and nitrogen reduction has been completed. The process may be carried out in either aerobic or anaerobic conditions.

The processes of at least the first or second embodiments of the invention exhibit the additional advantage that, if the water to be treated additionally contains one or more metals in excess of approved discharge concentrations, the concentration of the metals remaining in the solution after it has been treated is typically substantially reduced, usually to a level below applicable discharge limits. This is particularly advantageous if the metal is toxic to the ecosystem of the receiving body or is toxic to humans. Metals that may be substantially removed from water in this way include arsenic, cadmium, chromium, copper, lead, mercury, nickel and zinc. In the processes described herein, at least in accordance with the second embodiment of the invention, metals present in the water to be treated are removed in the solid phase that is separated from the treated water in step (c), and are substantially immobilised in the solid phase so that the solids typically comply with the Toxicity Characteristic Leaching Procedure.

The use of the treating substance in the processes of the present invention, in addition to enabling water to be treated with significantly lower amounts of metal ions such as iron ions (compared to prior art processes), facilitates separation of the solids precipitated when the metal ions are added to the water and thus allows water to be treated with the use of substantially reduced amounts of filter aids, flocculating agents, and the like, which are typically called for in prior art processes. The presence of the treating substance in the separated solids improves their bulk density and particulate nature and reduces their moisture content, compared to prior art processes, and thus reduces the effluent residual suspended solids content. Typically, the suspended solids content of the treated water produced by the process of the present invention is substantially less than 20 mg/L.

Additionally, when the solids removed in step (c) of the process of the second embodiment are combined with the underflow from primary or secondary sedimentation processes, they similarly enhance the physical properties of the combined inorganic and organic sludges so that the efficiency of the polyelectrolyte flocculants used in the conventional solids separation is significantly improved.

Furthermore, it has been found, surprisingly, that neither the treated water produced by the processes of the first or second embodiments of the invention, nor the sludge (solids) separated from the treated water develops an odour over time, such as when the sludge is disposed of as landfill or when the sludge or the treated water are used for agricultural application such as a soil supplement, as a supplement to a composting process, or for irrigation. In particular, the treated effluent may be stored without further odour development for extended periods if so desired. The separated solids that contain the treating substance and precipitated inorganic phosphorus compound(s), furthermore, have the property that when added to biological wastes that have a propensity to develop odour on storage or use, they inhibit that propensity.

In one particular form of the invention, therefore, there is provided a process for eliminating and preventing the redevelopment of odour from biosolid sludges separated from aqueous wastewater by clarification, settling, and separation, in which the solids removed in step (c) of a process according to the second embodiment of the invention are combined with the biosolids underflow from a wastewater treatment plant prior to dewatering. This process is particularly applicable to biosolids from a sewage treatment process.

In summary, as a result of the application of the process of the invention the following benefits may be achieved:
the amount of metal ion chemical required for maximum removal of phosphorus is reduced from the conventionally experienced molar ratio of metal to phosphorus of about 10 to a value of less than 2, typically in the range of 1.4-2,
the pH range for the lowest theoretically achievable residual phosphorus concentration is markedly extended,
the amount of polyelectrolyte required for solids separation is reduced substantially, typically by about 50%,
the effluent suspended solids is reduced below 20 mg/L,
the total effluent phosphorus (organic and inorganic phosphorus) is reduced below 0.5 mg/L,
the development of odour in the effluent is inhibited,
the development of odour in the sludge is inhibited,
the filterability of the sludge is improved,
time-dependent release of phosphorus from biosolids is eliminated,
the toxic metals concentration in the effluent is reduced, and
the toxic metals in the separated solids and suspended solids are immobilised.

The treating substance that contributes the particular advantageous properties to the process of the invention is preferably a material obtainable from Virotec International Pty Ltd, of Sanctuary Cove, Queensland, Australia, under the trademark Bauxsol.

In the processes of the invention, the solids may be sludge separated from wastewater such as sewage or industrial wastewater during conventional treatment processes, or they may be solids from any other source. Typically, the solids are insoluble or partially soluble materials of essentially biological origin that are contained as a suspension or dispersion in water. Usually, the solids will contain biologically active microorganisms.

The process of the invention may be part of any water or sludge treatment process whether part of a conventional sewage treatment process or any other process which may involve the separation of solid waste from liquid waste streams.

The amount of treating substance added in the processes of the invention will be sufficient to result in an increased settling rate, bulk density and/or filterability of the solids present, compared to the same property of sludge obtainable by a similar process without the use of the treating substance.

Similarly, in the processes of at least the third and fourth embodiments, the amount of treating substance added to the material having an odour or having the propensity to develop an odour is an amount sufficient to at least improve the odour and/or to at least diminish the propensity of the material to develop an odour. In these embodiments of the invention, the material is typically, but not necessarily, sewage sludge or compost. Other materials to which these processes are applicable include animal excrement, dredge spoil, garbage and the like.

In the processes of the third and fourth embodiments, the odour due to the presence of one or more sulfur-containing substances is usually the result of microbiological activity. That is, the odour is usually produced by microorganisms.

In the processes of the invention, and most particularly, the process of the second embodiment of the invention, the amount of treating substance used will typically be at least 5% by weight of the weight of solids present in the wastewater. It will be appreciated that the benefit of adding the treating substance is exhibited by any amount above the minimum effective amount, and so may be up to 100%, 150%, 200%, 250%, 300% or more by weight of the weight of solids present in the wastewater. The minimum effective amount may depend on the amount of solids present and/or the presence of various dissolved species, and/or other additives that are added to the wastewater. For any given application, the minimum effective amount of treating substance to be added may be readily determined by routine experimentation, given the teaching herein. As an example, where the wastewater is sewage prior to clarification, the amount of treating substance added will usually be in the range of about 10-100 mg/L or 10% to 50% by weight of the weight of solids present in the wastewater, even more usually about 50 mg/L or 25% by weight of the weight of the solids present in the wastewater.

Similarly, and particularly in relation to the process of the third and fourth embodiments, the amount of treating substance used will typically be at least 5% by weight of the material to be deodorised. Again, there is no particular benefit in adding more than the minimum effective amount, but the amount of treating substance added may be up to 100% by weight of the weight of material, or more. However, more usually the amount of treating substance added will be in the range of about 10% to 50% by weight of the weight of the material, even more usually about 25% by weight of the weight of the material to be deodorised.

Although the bauxite refinery residue known as red mud may be used directly as the treating substance in the processes of the present invention, more usually the treating substance is red mud that has been at least partially reacted with calcium and/or magnesium ions so as to have a reaction pH, when mixed with five times its weight of water, of less than 10.5, typically between 8.0 and 10.5.

In one preferred form, the process of at least the first or second embodiments of the invention relates to a process for separating solids from wastewater in which a polyelectrolyte is added to the wastewater to at least partially flocculate the solids and then the solids are separated from the wastewater by filtration, wherein the treating substance is added to the wastewater before the polyelectrolyte is added.

The polyelectrolyte used in this form of the process can be any polyelectrolyte known in the art to be useful for the separation of solids from wastewater. Examples of typical polyelectrolytes are polyacrylamides, hydrolysed polyacrylamides, polyacrylic acids, polymethacrylic acids, polyacrylic acid copolymers, various polyamines such as polyvinylamine, polyethylene amine, polyvinylpyridine, polyvinylpiperidine, polyvinylpyrrolidine and quaternized derivatives thereof, and the like.

Surprisingly, it has been found that by including the treating substance in the processes of the invention, various benefits are achieved, compared to the same process without the treating substance. The benefits include:

where the treating substance is added to wastewater before a primary clarification step: the bulk density and filterability of the solids separated in the primary clarification are improved;

where the treating substance is added to the wastewater in or after a primary clarification step: the bulk density, particulate nature and filterability of the solids precipitated from the wastewater is improved so as to reduce the amount of filter aid and polyelectrolyte flocculating agent required to dewater the solids; and

the sludges produced by the process are stabilised with respect to the presence of odour or odour development, so as to facilitate environmentally acceptable disposal or further processing.

For example, typically, in existing processes the solids are produced from a wastewater clarification process in the form of sludge with a solids content of 0.5-1.0%. After dewatering the sludge in the presence of a polyelectrolyte in a prior art process, whether by belt filtration, dissolved air flotation or other means, the solids content typically increases to 10-12%. The addition of 25% by weight, based on the weight of solids present, of the treating substance to the sludge, either as an aid to, or after, clarification, provides a cake with a solids content of 14-17%, and typically requires only 40-55% of the normal polyelectrolyte dose due to improved dewatering efficiency.

A filter aid and/or one or more other conventional water treatment additives may optionally be employed in the process of the first or second embodiment. A typical filter aid is diatomaceous earth. The treating substance may be added at the same time as, before or after other additives, depending on the nature of the additive. The treating substance may be added at any stage in the wastewater treatment process. It may be added to untreated, fresh sewage (influent) or at any stage within a wastewater treatment plant. However, it is preferably added after primary sedimentation and clarification is completed and more preferably it is added to the discard biosolids liquor, after secondary sedimentation and clarification is completed.

In another preferred form of the process of the second embodiment, in which the wastewater contains dissolved phosphorus-containing compounds, an amount of at least one metal ion is added to the wastewater sufficient to at least partially precipitate a phosphorus-containing compound of the at least one metal, and the treating substance is dispersed in the water before adding the at least one metal ion. In this form of the process, the solids may be separated along with the precipitated phosphorus-containing compound and separated from the treated water together.

In this form of the process of the second embodiment, the metal ion is typically at least one of iron, aluminium and calcium, still more typically iron, which may be ferric or ferrous iron or a mixture of the two. The amount added is typically not more than 1.5 times the stoichiometric amount required to react with the amount of dissolved phosphorus present, but an excess could be added if so desired. Suitably, the metal ion is added as a soluble salt of the metal such as a chloride, sulfate or the like. Optionally, the pH of the water may be adjusted, suitably to a pH in the range of about 6.5 to 7.5, between the addition of the treating substance and the addition of the one or more metal ions.

This form of the process of the second embodiment is usually carried out on wastewater from which some solids have already been removed by a settling and clarification step. In this form of the process of the second embodiment, the amount of treating substance added to the wastewater will usually be about 1 g/L or more of water to be treated, but will more usually be not more than about 0.5 g/L, still more usually not more than about 0.3 g/L, even more usually up to about 0.25, 0.2, 0.15 or 0.1 g/L yet more usually up to about 50 mg/L. Typically, the amount of treating substance added will be about 50 mg/L.

In one form of the processes of the invention, and in particular, the processes of the third and fourth embodiments, the material having an odour or having the propensity to develop an odour may be sludge separated from a sewage treatment process. In this form of the processes, the addition of the treating substance to the sludge may be achieved by adding the treating substance to the sludge after it has been removed from the bulk of the wastewater with which it is associated. Alternatively, and more preferably, the treating substance may be added to the wastewater prior to the separation of the sludge from the water. As in the process of the first or second embodiment, optionally other conventional additives for flocculating and/or coagulating the solids present and/or for precipitating dissolved species present (such as phosphorus compounds) may be added to the wastewater. Such conventionally used additives include polyelectrolytes as exemplified above, filter aids and metal ions such as iron and/or aluminium ions.

The processes of the third and fourth embodiments provide significant advantages over prior art processes in which the treating substance is not used, in that the materials treated by the processes of the third and fourth embodiments have a reduced odour and do not develop a disagreeable odour over time, or during further processing, to the same degree as the materials without the treating substance added to them. Typically, the odour of materials treated by the process of the fourth embodiment does not change appreciably during storage of the treated materials over a period of days or even weeks.

Similarly, in a composting process of the fifth embodiment, the odour of the composting material is typically substantially reduced during the composting process, and the development of odour during the composting process and subsequent storage of the compost is substantially reduced, typically substantially eliminated.

In addition to the advantages of the processes of the invention as described above, sludges and other solids or treated materials obtained by the processes of the invention have an increased ability to retain metal ions. Thus, if a sludge contains toxic metals that would tend to leach out over time, the addition of the treating substance to it will reduce the propensity of the metals to be leached out, typically to the point where the sludge complies with the Toxicity Characteristic Leaching Procedure (TCLP; USEPA method 1311). Thus, untreated sludges containing toxic metals obtained without the use of the treating substance may not be capable of being discharged to the environment, whereas sludges obtained by the processes of the present invention which pass the TCLP test, may not be precluded from being discharged to the environment on the basis of their toxic metals content.

In the process of the fifth embodiment, the treating substance may be added to the compostable material together with, or separately from, the material containing microorganisms. Preferably, the material containing microorganisms and the treating substance are added together. More preferably, the material containing microorganisms and the treating substance are added together in the form of sludge separated from sewage by a process of the second embodiment. Still more preferably, the mixture of sludge and treating substance is produced by combining the underflow from a clarification step in a sewage treatment process with solids that have been separated from the overflow of the clarification step using a form of the process of the second embodiment in which one or more metal ions is added to the overflow after the treating substance is added to it, in order to precipitate insoluble phosphorus-containing compounds of the one or more metals. It will be appreciated that in this form of the process of the fifth embodiment, the phosphorus present in the mixture of sludge and treating substance added to the compostable material can be beneficial to the composting process and/or can be beneficial if the compost produced by the process of the fifth embodiment is used as a soil supplement or fertiliser. In this form of the process of the fifth embodiment the amount of treating substance added to the overflow will typically be equal to about 25% by weight of the total solids present in the underflow and the overflow.

The quantity of treating substance to be used in a process of the fifth embodiment of the invention will typically be in the range of about 2% to 20% by weight of the compostable material. Greater amounts may be employed but there is no particular benefit from doing so. Usually, the amount of treating substance is in the range of about 5-10% by weight, more usually about 7% by weight, of the weight of the compostable material. In a preferred form of the processes of the invention, the treating substance is added together with the biosolids, in a ratio of about 1 part by weight of the treating substance to about 3 parts by weight of the biosolids.

In the process of the fifth embodiment, the material containing microorganisms may, as described above, be sewage sludge obtained by a process of the second embodiment, or it may be any other convenient source of microorganisms. Examples of such sources include animal biosolids such as manure; dredge spoil; rotting garbage; worm casts; leaf mould; humus and active loam.

Apart from odour reduction, which is a significant benefit of the process of the present invention, the process of the fifth embodiment provides other advantages over prior art composting processes in which none of the treating substance is present.

For example, the rate of composting of the biomass is accelerated in the process of the fourth embodiment, and thereby the temperature of the composting mass is increased and the pathogen content of the composted mass is substantially reduced. This presents commercial benefits through increased throughput in commercial composting facilities and improved saleability of the compost produced because of its lower pathogen content. In one known composting operation, dewatered sludge (“biocake”) is mixed in a 1:4 ratio with imported green waste using a front-end loader. It is then composted in windrows for 11-14 weeks, turned regularly to aerate the composting mass, and the final product used for various agricultural and horticultural purposes. In the process of the fifth embodiment, the time taken for completion of the composting process is typically reduced to 6-8 weeks, as judged by the pH reaching 7-8 and the compost internal temperature falling to less than 50° C.

The process of the fifth embodiment is not limited in application to such a process, however, and may be employed with advantage in all composting processes. Thus, the process of the fifth embodiment is applicable to all composting processes that are known in the art, regardless of the materials handling technology involved, to give accelerated composting rates.

Additionally, it has been found that in the process of the fifth embodiment, the amount of compostable material that needs to be added to the material containing microorganisms in order to obtain a suitable compost product is substantially reduced. In situations where the compostable material must be purchased, this provides a substantial benefit. In a process of the fifth embodiment in which the material containing microorganisms is sewage sludge, the ratio of amounts of sludge to compostable material is typically about 1:2.5 by weight, whereas in the absence of the treating substance, the ratio is typically about 1:4 by weight.

Furthermore, it has been found that the compost obtained by the process of the fifth embodiment typically has an improved texture, compared to the compost of the prior art process, and improved water-retaining ability.

The treating substance for use in the processes of the invention is preferably a material obtainable from Virotec International Pty Ltd, of Sanctuary Cove, Queensland, Australia, under the trademark Bauxsol.

### EXAMPLES

The following Examples are included to illustrate the invention, but they are not intended to place any limitation on the scope of the invention. In each of the Examples, the treating substance used was Bauxsol™ additive.

### Example 1

### Biosolids Filtration Trials

In this and subsequent trials, the amount of Bauxsol™ added was calculated to be 25% of the total biosolids dry weight in the sludge or waste water source.

A. Laboratory-Scale Investigation into Treatment of Biosolids Sludge Resulted In:
a marked increase in percent solids of biocake of between 3-5%;
a reduction of 60% of polyelectrolyte required;
a dramatic reduction in odour from both treated liquor water and biocake.
   B. Pilot Plant Testing on Raw Sludge, and Biosolids Sludge from a Municipal Sewage Treatment Plant.

To 1000 L of secondary-treated sewage wastewater containing 5 mg/L phosphorus as P, and 20 mg/L suspended biosolids, 50 g of Bauxsol was added, followed by 50 g ferric chloride. The treated water contained less than 0.1 mg/L P and 2 mg/L suspended solids. The phosphate-rich sediment was harvested by decantation and collection of slurry (3 L volume). This sediment slurry was then added to 30 L of discard biosolids liquor from the same treatment plant, with a solids content of 0.6%. To the mixture, 180 mL of polyelectrolyte was added (44% of the normal addition rate) and filtered on a belt filter to produce treated biocake with a solids content of 17%. The proportion of Bauxsol thus added was 25% of the combined biosolids from the discard liquor and the phosphorus precipitation step.

### Example 2

### Laboratory Scale Experiments on Water Containing Phosphorus Ions

A simulated phosphorus containing wastewater was prepared, consisting of an aqueous solution of potassium dihydrogen phosphate containing 6.09 mg/L phosphorus.

### Procedure

To 200 ml samples of the phosphorus containing water was added ferric chloride in amounts corresponding to 0.84, 0.94, 1.12, 1.40 and 1.87 times the stoichiometric requirement for the complete precipitation of phosphorus as the insoluble ferric phosphate compound and, after 10 min, the pH of the resultant solution was adjusted to pH 6.5-7.5 with sodium carbonate. The solutions were filtered through a 0.47 micron filter and the filtrate was analysed for pH and phosphorus (Ascorbic Acid Method 4500-P E, Standard Methods For the Examination of Waters and Waste Waters, 19^{th} Edition, 1995, APHA AWWA WEF. 4-113, 5). Analytical results below 0.05 mg P/litre were confirmed by ion chromatography. The level of detection of this procedure is 0.01 mg P/litre and the reproducibility was determined by replicate determinations to be ±0.02 at 95% confidence.

The above experiments were concurrently repeated by adding 10, 20 and 50 mg/L Bauxsol™ 10 minutes prior to the ferric chloride additions.

The measured phosphorus concentrations were compared with the theoretical minimum concentration for the pH at which the precipitation was measured to occur.

The results are presented in Tables 1.1 to 1.5.

TABLE 1.1
Phosphorus (mg/L) determined after 2 hours

Bauxsol (mg/L)

| Fe/P | 0 | 10 | 20 | 50 |
|---|---|---|---|---|
| 0.84 | 1.36 | 1.15 | 1.07 | 0.73 |
| 0.94 | 1.61 | 0.93 | 0.79 | 0.73 |
| 1.12 | 0.73 | 0.51 | 0.41 | 0.25 |
| 1.40 | 0.38 | 0.04 | 0.23 | 0.04 |
| 1.87 | 0.04 | 0.08 | 0.03 | 0.14 |

TABLE 1.2
pH after phosphorus determination

Bauxsol (mg/L)

| Fe/P | 0 | 10 | 20 | 50 |
|---|---|---|---|---|
| 0.84 | 7.00 | 6.82 | 6.78 | 7.43 |
| 0.94 | 7.80 | 7.13 | 7.48 | 7.68 |
| 1.12 | 7.60 | 7.68 | 7.72 | 7.65 |
| 1.40 | 7.64 | 7.55 | 7.62 | 7.65 |
| 1.87 | 7.60 | 7.52 | 7.56 | 7.67 |

It can be seen from Table 1.1 that, in the presence of Bauxsol™, the ferric chloride reaction procedure consistently removes phosphorus from the wastewater to a level significantly below the minimum theoretical level for the conventional ferric chloride process, and to a level below that obtainable through the use of ferric chloride alone, except for relatively large additions of ferric chloride.

Further, although the ferric chloride reaction is reportedly adversely affected by pH outside the range of pH 6.8-7.2, the presence of Bauxsol™ enables the reaction to proceed outside that range. This pH phenomenon therefore considerably reduces the risk of treatment failure resulting from unexpected changes in wastewater pH.

It is known that in the ferric chloride reaction with ions of phosphorus species, the minimum residual phosphorus concentration is related to the pH at which the precipitation occurs. Thus comparisons of efficiency must be made at constant pH.

Accordingly, Table 1.4 compares the measured residual phosphorus concentration against the theoretical value at the same pH (shown in Table 1.3). In this comparison values above 1 indicate that incomplete precipitation has occurred. However Table 1.4 clearly illustrates that, at Bauxsol™ levels of 10 mg/L and above, complete precipitation of phosphorus is achieved at Fe/P molar ratio between 1.1 and 1.4 whereas in the absence of Bauxsol™ complete precipitation requires Fe/P molar ratio substantially greater than 1.4.

TABLE 1.3
Theoretical minimum residual phosphorus at pH of precipitation

Bauxsol (mg/L)

| Fe/P | 0 | 10 | 20 | 50 |
|---|---|---|---|---|
| 0.84 | 0.04 | 0.04 | 0.04 | 0.14 |
| 0.94 | 0.33 | 0.05 | 0.18 | 0.28 |
| 1.12 | 0.23 | 0.28 | 0.30 | 0.25 |
| 1.40 | 0.25 | 0.20 | 0.24 | 0.25 |
| 1.87 | 0.23 | 0.19 | 0.21 | 0.28 |

TABLE 1.4
Ratio of measured phosphorus to theoretical minimum phosphorus

Bauxsol (mg/L)

| Fe/P | 0 | 10 | 20 | 50 |
|---|---|---|---|---|
| 0.84 | 34.00 | 28.75 | 26.75 | 5.21 |
| 0.94 | 4.88 | 18.60 | 4.39 | 2.61 |
| 1.12 | 3.17 | 1.82 | 1.37 | 1.00 |
| 1.40 | 1.52 | 0.20 | 0.96 | 0.16 |
| 1.87 | 0.17 | 0.42 | 0.14 | 0.50 |

The values calculated in Table 1.5 represent the phosphorus concentration to be expected if the reactions were all completed at pH 6.8-7.0. The values were obtained by interpolation of the analytical data into the graphical data of FIG. 3.2 of Biological and Chemical Systems for Nutrient Removal; Water Environment Federation, Virginia, USA; Municipal Subcommittee of the Technical Practice Committee; 1998 and, for the values less than 0.04 mg/l, are limited in significance by the reproducibility of the method. However the method has demonstrated a lower detection limit of 0.01 mg/L and Tables 1.1, 1.4 & 1.5 support a tentative conclusion that the presence of Bauxsol™ may allow residual phosphorus concentration less than the theoretical minimum value possible with the ferric ion reaction.

TABLE 1.5
Phosphorus concentration corrected for pH after phosphorus
determination

Bauxsol mg/L

| Fe/P | 0 | 10 | 20 | 50 |
|---|---|---|---|---|
| 0.84 | 1.36 | 1.07 | 0.97 | 0.19 |
| 0.94 | 0.20 | 0.08 | 0.19 | 0.11 |
| 1.12 | 0.13 | 0.07 | 0.05 | 0.04 |
| 1.40 | 0.06 | 0.01 | 0.04 | 0.01 |
| 1.87 | 0.01 | 0.02 | 0.01 | 0.03 |

### Example 3

### Laboratory Scale Treatment of Raw Sewage Influent Containing Phosphorus

### Procedure

To 1000 ml samples of phosphorus-containing raw sewage was added ferric chloride in amounts approximating the stoichiometric requirement for the complete precipitation of phosphorus as the insoluble ferric phosphate compound. The solutions were allowed to settle and the supernatant liquor was analysed for pH and phosphorus. The level of detection of this analytical procedure was 0.03 mg P/litre.

In these experiments the sludge volume of the precipitated ferric phosphate and biosolids was estimated. The above experiment was concurrently duplicated by adding 87 mg/l Bauxsol™, 10 minutes prior to the ferric chloride additions.

The results are presented in Table 2.

TABLE 2

| ^{Fe}/_{P} | Bauxsol ™ | Residual Phosphorus | | Sludge |
|---|---|---|---|---|
| Stoichiometric | mg/L | mg/L | pH | Volume % |
| 0 | 0 | 12.4 | 7.85 | n.a. |
| 0.75 | 0 | 7.5 | 7.1 | 10 |
| 1.5 | 0 | 1.95 | 6.3 | 10 |
| 1.0 | 87 | Not detected | 6.9 | 4 |

In this experiment Bauxsol™ was added at a rate of 87 mg/L although it was subsequently discovered that increasing Bauxsol™ above 50 mg/L has no effect on the process. These experiments indicate that in raw sewage the addition of Bauxsol™ to the conventional ferric ion precipitation process for the removal of phosphorus ions removed phosphorus from the wastewater to a level below the detection level and significantly below the minimum theoretical level for the conventional ferric chloride process. Further, the sludge volume of ferric hydroxide, ferric phosphate and biosolids in the presence of Bauxsol™ is shown to be approximately 40% of the volume produced by ferric chloride alone.

### Example 4

### Laboratory Scale Treatment of Odorous Biosolids from Raw Sewage

### Procedure

Biosolids from Pine Rivers STP were treated with either Bauxsol™ alone or Bauxsol™/iron phosphate sediment collected from treatment of final effluent.

The ratio of solids in the mix was 1:3 on a dry weight basis (i.e. 25% Bauxsol additive to biosolids.)

### Odour Species Characterisation

10 g of untreated biosolids was placed in a headspace vial and sealed. 10 g of treated biosolids was sealed in another vial. The headspace air composition in the two vials was analysed using GCMS and GC-Flame Photometric detector (which is specific for S-compounds).

In the untreated biosolids vial the species identified were:

| | |
|---|---|
| Hydrogen Sulphide | >2000 ppm |
| Methyl Mercaptan | 100 ppm |
| Thiols & sulphides | Trace |
| Dimethyl sulphide | 1 ppm |

In the treated biosolids vial the species identified were:

| | |
|---|---|
| Dimethyl sulphide | 1 ppm |

Both vials were analysed periodically over a number of weeks and although the untreated biosolids vial continued to generate odorous species, the treated biosolids vial contained only the low level dimethyl sulphide species which is substantially odourless. It was subjectively observed that the untreated biosolids emitted a characteristic odour consistent with that of hydrogen sulphide, mercaptans and thiols, whereas the treated biosolids were almost odourless.

This experiment illustrates the effect of Bauxsol™ in the removal of odorous substances from wastewater and wastewater biosolids and in the inhibition of the development of odours with aging of the treated biosolids and wastewater treated effluent.

### Example 5

### Pilot Plant Treatment of Wastewater Containing Phosphorus and Suspended Solids

### Procedure

1000 litres of raw sewage containing 13 mg/L of phosphorus at pH 7.65 was treated in the following sequence.

1. Add 100 mg/L Bauxsol™.

2. After 10 min add 100 mg/L ferric chloride (FeCl₃.6H₂O), 30 mg/L ferrous sulfate (FeSO₄.7H₂O) and 5 mg/L ferric sulfate (Fe₂(SO₄)₃.9H₂O). (This is approximately 1.2 times the stoichiometric requirement for P precipitation.)

3. Allow to settle for 2 hours.

4. Harvest.

The process achieved a residual phosphorus concentration <0.07 mg/L and it was noted that the suspended solids agglomerated almost instantaneously and settled rapidly.

This process was carried out with Technical grade chemicals in a manner consistent with commercial operations and demonstrates that the procedure achieves close to minimum theoretical residual phosphorus at or near the minimum stoichiometric metal ion requirement and that the physical nature of the suspended solids was modified in a beneficial way.

### Example 6

### Pilot Plant Treatment of Partially Treated Wastewater Containing Phosphorus and Suspended Solids

### Procedure

1000 litres of treated water overflow from a secondary clarifier post BNR treatment containing 5.55 mg/L phosphorus was treated in the following sequence

1. Add 50 mg/L Bauxsol™.

2. After 10 min add 50 mg/L ferric chloride 90% (1.5 times the stoichiometric requirement for P precipitation).

3. Allow to settle for 2 hours.

4. Harvest.

The process achieved a residual phosphorus concentration <0.07 mg/L.

This process was carried out with Technical grade chemicals in a manner consistent with commercial operations and demonstrates that the procedure achieves close to minimum theoretical residual phosphorus at or near the minimum stoichiometric metal ion requirement.

### Example 7

### Laboratory Scale Measurements of Sludge Volume on Water Containing Phosphorus Ions

### Procedure

To 200 mL phosphate solution, in measuring cylinders, was added ferric chloride in amounts approximating the stoichiometric requirement for the complete precipitation of phosphorus as the insoluble ferric phosphate compound. The sludge volume of the precipitated ferric phosphate and hydroxide was measured at 10, 30 and 60 minutes after addition of the precipitants. The above experiment was concurrently duplicated by adding 50 mg/L Bauxsol™, 10 minutes prior to the ferric chloride additions.

The results are presented in Table 3

TABLE 3

| | Bauxsol and ferric chloride | | | Ferric chloride only | | | | | |
|---|---|---|---|---|---|---|---|---|---|
| | Sludge Volume in mL. | | | | | | Sludge volume ratio | | |
| Fe/P | 10 min | 30 min | 60 min | 10 min | 30 min | 60 min | 10 min | 30 min | 60 min |
| 0.84 | 19 | 16 | 12 | 17 | 11 | 10 | 1.12 | 1.45 | 1.20 |
| 0.94 | 14 | 10 | 10 | 9 | 8 | 8 | 1.56 | 1.25 | 1.25 |
| 1.12 | 14 | 10 | 10 | 33 | 18 | 15 | 0.42 | 0.56 | 0.67 |
| 1.40 | 16 | 12 | 11 | 19 | 14 | 14 | 0.84 | 0.86 | 0.79 |
| 1.59 | 20 | 15 | 14 | 13 | 12 | 12 | 1.54 | 1.25 | 1.17 |
| 1.87 | 16 | 13 | 13 | 14 | 13 | 13 | 1.14 | 1.00 | 1.00 |

It can be seen that in the region of interest (1.0-1.5 times stoichiometric iron addition) the presence of Bauxsol™ reduces the initial sludge volume by 40-50% and also increases the initial incremental settling rate.

### Example 8

### Biosolids Odour and Storage Trials

Both treated and untreated biocake were stored in open and closed containers for several weeks and their odours compared at regular intervals. By “treated biocake” is meant biocake which had been mixed with 25% by weight, on a dry solids basis, of Bauxsol™ additive. Qualitative odour levels were determined subjectively by 3 observers.
For treated and untreated biocake stored in sealed containers, the odour of the untreated biosolids was found to be strongly objectionable, however odour from the treated biosolids was assessed as “detectable, but not objectionable”. Visible differences of colour and texture between the two samples were also noted.
The biocake stored in open containers exhibited the greatest differences in odour. Untreated biocake developed a very strong, objectionable, “rotting sewage” odour whereas treated biocake odour was described as like “moist earth” with no objections from observers. Even after 3 weeks, no objectionable odours were detected from treated biosolids.
The treated biocake has been shown to meet the New South Wales EPA guidelines for disposal and re-use in agriculture.

### Example 9

### Large Scale Bulk Density and Filterability Trials

Two 1000 L plastic containers were used to dispense Bauxsol™ at a rate equivalent to 25% of the dry weight of biosolids into the biosolids stream prior to a belt press. The addition rate of polyelectrolyte prior to filtration was varied in the range 1.0-13.7 mL/L (the typical rate for this plant is 13.7 mL/L) and the treated biosolids were de-watered on the belt press, collected and removed for composting trials (see Example 4). The belt speed and tension of the gravity belt were adjusted for optimum use.

At 5.0 mL/L of polyelectrolyte, dewatering appeared to be identical to that achieved in the absence of Bauxsol™ but with 13.7 mL/L of polyelectrolyte instead of 5 mL/L. At 6.0 mL/L of polyelectrolyte, the maximum solids content (14.2%) of the biocake was achieved. At 7.25 mL/L (53% of untreated operating dose) the texture of the biocake was subjectively judged to be optimum.

The resultant biocake had a different texture (being more spongy than biocake produced in the absence of Bauxsol™) and had no objectionable odours. The test was continued for the entire day with a total of 415 kilolitres of biosolids liquor being processed. The biocake percent solids was calculated to be 14%, compared with untreated biocake solids at 10.5%.

In another similar test the treated biocake “stood up” to an angle of approximately 50° in the truck indicating an advantageously higher packing density. In this second test a total of 494 kilolitres of biosolids liquor were treated with resultant percentage solids of 14.2%.

### Example 10

### Composting Trials

At the facility where the trials were carried out the biocake is normally transferred by truck from the municipal treatment plant and then mixed in a 1:4 ratio by weight with imported green waste using a front-end loader. It is then composted in windrows for 11-14 weeks being turned regularly to aid in composting, and the final product is used in council parklands.

For the trial, the biocake from Example 9 was unloaded into two heaps and then mixed with green waste in 1:1 and 1:3 ratios. The piles were turned regularly and observations were recorded by the loader operator.

The 1:1 and 1:3 piles both stood up well and did not sag or collapse. After six days it was agreed that the 1:1 pile was not composting efficiently, so more green waste was added to bring it to a 1:2.25 blend. Sufficiently high temperatures were subsequently achieved within 24 hours. Large clouds of steam were released from the two piles, during movement by heavy plant equipment. Temperatures were determined utilising standard thermocouple probes during the composting process and were shown to exceed 75° C. with an average temperature in excess of 65° C. No leaching from either pile was evident even after rain events, and minimal odour was detected throughout the process.

After 10 days the 1:2.25 (formerly 1:1) pile was deemed to be slowing down so it was dosed with dry sawdust to increase the ratio of biocake to green waste to 1:2.5 which then raised the temperature to 49° C. and the pile was allowed to continue composting.

After 2 weeks both piles were in excess of 60° C. with no unpleasant odour. The colour of the two piles was a dark chocolate brown.

After 7 weeks the treated biosolids/green waste mix was pH 7-8 and internal temperature average of 50° C. or less and the composting process was deemed to be complete and the product ready for use.

The trial demonstrated that, in the presence of Bauxsol™
the rate of composting was increased markedly and reduced the production time from 11-14 weeks to 7 weeks;
the temperature of the composting mass exceeded 75° C. within 24 hours and averaged 65° C. (this temperature exceeds the normal pasteurising temperature required destroy pathogens);
the ratio of biocake to carbonaceous waste (green waste) required to produce a satisfactory product was decreased from 1:4 to 1:2.25.

### Example 11

### Compost Odour and Storage Trials

Five hundred litres of biosolids liquor was placed in a plastic container along with Bauxsol™ additive in an amount of 25% by weight of the dry weight of solids, and half the usual amount of polyelectrolyte. The solution was stirred and let stand for 30 minutes.

The treated biosolids were placed onto a belt press and de-watered. The resultant biocake was collected and placed into two 200 litre black plastic drums with sealable lids, along with green waste from the local public tip in 1:1 and 1:3 ratios.

An identical experiment was conducted using untreated biosolids (that is, with no Bauxsol added) for standardisation and control comparisons.

The drums were all left in a sunny position, watered, rolled and subjectively tested for odour daily over a one-month period.

The drums containing treated biocake consistently exhibited low odour compared with the untreated biosolids drums and composted to a smaller volume than the untreated material. After three months none of the treated biosolids composting trials exhibited any offensive odours or leachate.

### Example 12

### Compost Water Retention

The water retention capability of the compost produced from Bauxsol-treated and untreated biosolids and a proprietary potting mix was determined according to the following:

1000 g of each material was weighed, spread thinly onto a 250 mm square drying tray and subjected to oven drying at 105° C. until constant weight was attained. Results are presented in the Table 4.

TABLE 4

| | Initial | | | Time to |
|---|---|---|---|---|
| | Weight | Final Weight | | Constant |
| Material | (g) | (g) | % Moisture | Weight (hrs) |
| Potting Mix | 1000 | 860 | 14 | 5 |
| Untreated Biosolids | 1000 | 640 | 36 | 20 |
| Treated Biosolids | 1000 | 630 | 37 | 60 |

The potting mix material contained visible coarse sand material, was very friable and separated easily, thus allowing for rapid loss of water under the drying conditions. The compost from untreated biosolids was coarse compared to the compost from treated biosolids, which appeared as fine-grained, densely-packed material.

The compost produced from the Bauxsol-treated biosolids retained moisture under severe drying conditions for 3 times longer than untreated compost and 12 times longer than the proprietary potting mix.

1. A process for treating wastewater containing suspended solids comprising adding to the wastewater a treating substance in an amount sufficient to enhance at least one of (a) the settling rate of the solids, (b) the bulk density of the solids and (c) the filterability of the solids, said treating substance being selected from the group consisting of (i) bauxite refinery residue known as red mud, and (ii) red mud that has been at least partially reacted with calcium and/or magnesium ions so as to have a reaction pH, when mixed with five times its weight of water, of less than 10.5.

2. A process for reducing the concentration of dissolved phosphorus-containing species in water containing dissolved phosphorus-containing species, the process comprising the steps of
(a) dispersing in said water an amount of a treating substance,
(b) adding to said water an amount of at least one metal ion sufficient to at least partially precipitate a phosphorus-containing compound of said at least one metal, and
(c) removing solids present in said water therefrom to produce a treated water; wherein said treating substance is selected from the group consisting of (i) bauxite refinery residue known as red mud, and (ii) red mud that has been at least partially reacted with calcium and/or magnesium ions so as to have a reaction pH, when mixed with 5 times its weight of water, of less than 10.5.

3. The process of claim 2, wherein in step (b) the metal ion is selected from the group consisting of iron, aluminium and calcium, and a mixture thereof.

4. The process of claim 2, wherein in step (b) the metal ion is iron.

5. The process of claim 3, wherein in said iron metal ion is ferric or ferrous iron or a mixture of the two.

6. The process of claim 2, wherein the removal step (c) is preceded by settlement of the precipitated phosphorus-containing compound(s) and any other solids present, suitably until the supernatant water is clear.

7. The process of claim 6, wherein one or more flocculating agents is added.

8. The process of claim 2, wherein said process includes the additional step of adjusting the pH of the water before step (b).

9. The process of claim 8, wherein the adjusted pH is in the range of about 6.5 to 7.5.

10. The process of claim 2, wherein said process is applied to any soluble phosphorous-containing water.

11. The process of claims 1 or 2, wherein said water is discharged to a freshwater receiving body.

12. The process of claim 1 or 2, wherein said process further comprises the addition of a polyelectrolyte to the wastewater.

13. The process of claim 12, wherein said polyelectrolyte is selected from the group consisting of: polyacrylamides, hydrolysed polyacrylamides, polyacrylic acids, polymethacrylic acids and polyacrylic acid copolymers.

14. The process of claim 12, wherein said polyelectrolyte is a polyamine.

15. The process of claim 14, wherein said polyamine is selected from the group consisting of: polyvinylamine, polyethylene amine, polyvinylpyridine, polyvinylpiperidine, polyvinylpyrrolidine and quaternized derivatives thereof.

16. The process of claims 1 or 2, wherein said process further comprises the use of a filter aid.

17. The process of claim 16, wherein said filter aid is diatomaceous earth.

18. A process for decreasing the odour of a material having an odour due to the presence of one or more sulphur-containing substances, comprising adding to said material a treating substance in an amount effective to decrease the odour of the material, wherein the treating substance is selected from the group consisting of (i) bauxite refinery residue known as red mud, and (ii) red mud that has been at least partially reacted with calcium and/or magnesium ions so as to have a reaction pH, when mixed with five times its weight of water, of less than 10.5.

19. A process for decreasing the propensity of a material to develop an odour due to one or more sulphur-containing substances, comprising adding to said material a treating substance in an amount effective to inhibit the development of odour in the material, wherein the treating substance is selected from the group consisting of (i) bauxite refinery residue known as red mud, and (ii) red mud that has been at least partially reacted with calcium and/or magnesium ions so as to have a reaction pH, when mixed with five times its weight of water, of less than 10.5.

20. The process of claim 18 or 19, wherein said material is selected from the group consisting of sewage, sludge and compost.

21. The process of claim 19, wherein said odour is produced by microorganisms.

22. The process of claims 18 or 19, wherein the amount of said treating substance is at least 5% by weight of material.

23. The process of claim 22, wherein the amount of said treating substance is between 10 to 50% by weight of material.

24. The process of claim 22, wherein the amount of said treating substance is about 25% by weight of material.

25. A composting process in which a compostable material is mixed with an amount of a material containing microorganisms and the microorganisms convert the compostable material to compost, wherein the mixture of compostable material and the material containing microorganisms further contains a treating substance that is red mud that has been at least partially reacted with calcium and/or magnesium ions so as to have a reaction pH, when mixed with five times its weight of water, of less than 10.5.

26. The process of claim 25, wherein the amount of said treating substance is between 2 and 20% by weight of said compostable material.

27. The process of claim 25, wherein the amount of said treating substance is about 7% by weight of said compostable material.

28. The process of claim 25, wherein said material containing microorganisms and the treating substance are added together.

29. The process of claim 25, wherein said material containing microorganisms and the treating substance are added together in the form of sludge separated from sewage.

30. The process of claim 25, wherein said material containing microorganisms and the treating substance are added together.

31. The process of claim 29 or 30, wherein the amount of said treating substance is about 25% by weight of total solids.

32. The process of claim 25, wherein said material containing microorganisms is selected from the group consisting of: manure, dredge spoil, rotting garbage, worm casts, leaf mould, humus and active loam.

33. The process of any one of claims 1, 2, 18, 19, or 25, wherein the red mud that has been at least partially reacted with calcium and/or magnesium ions has a reaction pH, when mixed with five times its weight of water, of between 8.0 and 10.5.

34. The process of claim 2, wherein the red mud that has been at least partially reacted with calcium and/or magnesium ions has a reaction pH, when mixed with five times its weight of water, of between 8.0 and 10.5.

35. The process of any one of claims 1, 2, 18, 19, or 25, wherein said treating substance is Bauxsol™.
